(19) United States
(12) Patent Application Publication
(10) Pub. No.: US 2021/0363692 A1
(43) Pub. Date: Nov. 25, 2021

(54) A PROCESS FOR PROVIDING A TEXTILE WITH ELECTRICAL CONDUCTIVITY PROPERTIES

(71) Applicant: Sanko Tekstil Isletmeleri San. Ve Tic. A.S., Inegol - BURSA (TR)

(72) Inventors: Ozgur COBANOGLU, Inegol - BURSA (TR); Jitka ERYILMAZ, Inegol - BURSA (TR); Ece SENEL, Inegol - BURSA (TR); Deniz IYIDOGAN, Inegol - BURSA (TR); Semih KAZANC, Inegol - BURSA (TR); Erdogan Baris OZDEN, Inegol - BURSA (TR)

(21) Appl. No.: 17/280,331

(22) PCT Filed: Sep. 26, 2019
(86) PCT No.: PCT/EP2019/076104

§ 371 Date: Mar. 26, 2021

(30) Foreign Application Priority Data
Sep. 27, 2018 (EP) 18197348.8

(51) Int. Cl. D06M 16/00; D06M 11/74; D06M 15/05; D06M 15/15; D06M 23/16; D06N 3/00; D06N 3/02; G06F 3/044

(52) U.S. Cl. CPC D06M 16/003; D06M 11/74; D06M 15/05; D06M 15/15; D06N 2209/041; D06N 3/0063; D06N 3/02; G06F 3/044; D06N 2203/026; D06M 23/16

(57) ABSTRACT

The present invention relates to a process for producing an electrically conductive composite textile article, comprising a step of providing at least part of a textile article with a biopolymer, wherein at least part of said biopolymer comprises an electrically conductive material. The invention also relates to an electrically conductive composite textile article comprising a textile article and a biopolymer, wherein at least part of said biopolymer is provided with an electrically conductive material; and to a yarn, or a fabric, or a garment, consisting of, or essentially consisting of a biopolymer that can be produced by a microorganism, wherein at least part of said biopolymer is provided with an electrically conductive material.

### FIELD OF THE INVENTION

The present invention relates to the field of textiles, in particular to a process that is suitable to impart electrical conductivity properties to textile articles.

### BACKGROUND OF THE INVENTION

Electrically conductive articles that comprise electrically conductive impurities, dispersed within a polymer matrix, are known in the art.

Such known electrically conductive articles are suitable to be used in a variety of applications, such as, for example, electrodes, strain gauges, capacitive sensors, etc.

As above mentioned, in the known articles, generally, electrically conductive impurities, such as, for example, carbon, graphene, metallic nanoparticles (NPs), nano-sheets/rods/tubes, are dispersed in synthetic polymer matrixes.

Known synthetic polymer matrixes are, for example, polyurethane (PU), polyamide (PA), polypropylene (PP), poly lactic acid (PLA) and poly butylene terephthalate (PBT) matrixes.

However, such known articles have several drawbacks.

For example, synthetic polymer matrixes usually have fibers having a length and/or a polymerization degree such that it is difficult to obtain a satisfactory electrical conductivity performance of the overall article. Moreover, not all the combinations of synthetic matrixes and electrically conductive impurities result in reliably electrically conductive articles.

Also, the production of the known electrically conductive articles usually involves the use of chemical agents that may be harmful to humans. Additionally, fine tuning of the combination of matrix and conductive impurities (i.e., kind of impurity and final concentration thereof in the matrix) is required in order to obtain reliable electrical conducting properties in the known articles.

Another drawback in the production processes of known conductive articles is that is difficult to obtain a suitable dispersion of the conductive impurities in the matrix.

The use of biopolymers in the field of textiles is also known, for example, from International patent applications WO2017186584A1, WO2017186583A1, and PCT/EP2019/058800, in the name of the present applicant.

### SUMMARY OF THE INVENTION

It is an aim of the present invention to solve the above mentioned problems and to provide a process which allows for the production of article having electrical conductivity properties in a fast and cost-effective way.

Another aim of the present invention is to provide a process which allows to obtain an article having electrical conductivity properties which is reliable and that may be used for several applications.

A further aim of the present invention is to provide a process wherein an electrically conductive material may be easily included into a matrix.

These and other aims are achieved by a process according to claim 1, which is an object of the present invention.

Also object of the present invention is an electrically conductive composite textile article according to claim 14.

A further object of the invention is a yarn, a fabric, or a garment consisting of, or essentially consisting of a biopolymer which is at least in part provided with an electrically conductive material, according to claim 19.

The dependent claims relate to preferred embodiments of the invention.

The present invention relates to a process for producing an electrically conductive composite textile article, wherein at least part of a textile article is provided with a biopolymer, and wherein at least part of the biopolymer is provided with an electrically conductive material.

It has been surprisingly found that, through the process of the invention, a reliable electrically conductive article, in particular, a composite textile article having reliable electrical conductivity properties, may be obtained.

Advantageously, the process of the invention allows for the production of articles that are suitable to be used in textile industry, e.g., to produce garments, clothing articles or other items having electrical conductivity properties, in an easy, fast and cost effective way.

Additionally, the biopolymer can be obtained in a particularly sustainable way.

According to embodiments, the step of providing at least part of a textile article with a biopolymer comprises a step of contacting at least part of the textile article with a culture of biopolymer-producing microorganisms, and culturing the biopolymer-producing microorganisms, so that at least one biopolymer is produced on the textile article.

In this way, advantageously, the biopolymer, which is grown directly onto the textile article, strictly adheres to the textile article. In this case, advantageously, the detachment of the biopolymer from the textile article is avoided or substantially avoided.

Additionally, the growth of the biopolymer can be finely regulated so that a biopolymer having a specific thickness may be obtained, for example, directly onto the textile article.

As used herein, the terms “biopolymer” and “microbial polymer” refer to a polymer the can be produced by a microorganism.

As used herein, the term “microorganism” refers to small unicellular or multicellular living organisms that are too small to be seen with naked eye but are visible under a microscope, and encompasses bacteria, yeast, fungi, viruses and algae. As used herein, the term “microorganism” encompasses not genetically modified (i.e. wild type) microorganisms and genetically modified microorganism. For example, a microorganism can be genetically modified in order to produce a biopolymer which is not produced by the same microorganism when it is not genetically modified (i.e., when it is a wild type microorganism).

According to embodiments, at least part of the textile article may be coupled with a separately produced biopolymer.

For example, a biopolymer may be produced according to known methods, and it can be subsequently coupled with a textile article, e.g., with a woven fabric, by cross-linking or by sewing the biopolymer to the textile article. According to embodiments, a separately produced biopolymer, e.g., microbial cellulose, does not need to be dissolved before being provided to the textile article.

According to an aspect, the process of the invention allows to obtain an electrically conductive biopolymer, e.g., a conductive microbial cellulose. In particular, the biopolymer including the conductive material substantially retains the same structural characteristics (e.g., crystal structure, nano-porous network structure) of the same biopolymer when it does not include the conductive material.

According to embodiments, the biopolymer is provided to the textile article according to a pattern.

In embodiments, when the biopolymer is provided to the textile article, e.g., according to a pattern, the electrically conductive material may be provided to the entire or to substantially the entire biopolymer, for example by impregnation.

According to embodiments, the electrically conductive material is applied to the biopolymer according to a pattern.

According to embodiments, the textile article may be provided with a biopolymer, which is at least in part provided with a pattern of electrically conductive material.

For example, the textile article may be coated or substantially coated with a biopolymer, e.g., with a layer of biopolymer, wherein the biopolymer is provided with a pattern of electrically conductive material.

For example, a pattern of electrically conductive material may be provided to the biopolymer (e.g., to a biopolymer layer) by printing (e.g., screen printing and/or digital printing), or by localized impregnation.

Exemplary patterns of biopolymer and/or electrically conductive material may be one or more stripes, arrays of squares or circles or any other shape, such as grids.

Advantageously, in embodiments, the biopolymer and/or the electrically conductive material may be provided as a continuous layer of any arbitrary shape. In this case, advantageously, the electrically conductive composite textile article results to be particularly suitable for the production of tap and touch switches.

As used herein, the terms “electrically conductive material” and “conductive material” refer to a material that allows the flow of an electrical current, i.e., to a material having electrical conductivity properties. The presence of the electrically conductive material allows transmission of a current through a textile article provided with said material.

According to embodiments, the textile article is selected from the group consisting of a yarn, a fabric and a garment.

According to embodiments, the textile article is a yarn which may be provided, at least in part, with the biopolymer.

A yarn may be provided with a biopolymer according to known methods. For example, a yarn may be at least in part provided with a biopolymer by culturing biopolymer-producing microorganisms directly on the yarn. A culture containing biopolymer-producing microorganisms may be provided to a yarn through known methods, for example by spraying or by dipping the yarn into the culture containing biopolymer-producing microorganisms.

According to embodiments, the textile article is a yarn which may be coated, at least in part, with the biopolymer.

According to embodiments, the textile article is a fabric, preferably a woven fabric, and more preferably is a denim fabric.

According to embodiments, the fabric may include natural yarns and/or synthetic yarns and/or regenerated yarns or fibers, and/or mixed yarns.

In the present description, natural yarns are yarns that include natural fibers, which may be selected from cotton, wool, flax, kenaf, ramie, hemp, linen and mixtures thereof.

In the present description, synthetic yarns are yarns that include synthetic fibers, which may be selected from polyester, rayon, nylon, lycra, elastane and mixtures thereof.

In the present description, regenerated yarns are yarns that include regenerated fibers. Regenerated fibers, or man made fibers, are commercially available. For example, suitable regenerated fibers can be selected from rayon, lyocell, modal, viscose, bamboo, and mixture thereof.

According to embodiments, the fabric may comprise regenerated yarns or fibers, and/or blended yarns, i.e., yarns comprising regenerated fibers and natural fibers (e.g., cotton) and/or synthetic fibers. According to embodiments, yarns may comprise regenerated fibers, and/or a blend of regenerated fibers and natural fibers (e.g., cotton) and/or synthetic fibers.

Suitable yarns including regenerated cellulosic fibers and cotton fibers are e.g. disclosed in co-pending application EP18184992.8 in the name of the present applicant.

In the present description, mixed yarns are yarns that include both natural (e.g., cotton) and synthetic fibers.

According to embodiments, the textile article may be elastic, i.e. a stretchable textile article.

According to embodiments, the textile article is an elastic textile article, i.e. a stretchable textile article, preferably an elastic fabric, more preferably an elastic woven fabric, even more preferably an elastic denim fabric.

According to embodiments, the textile article may be an elastic yarn, i.e., a stretchable yarn.

For example, when the textile article is a woven fabric, weftwise elasticity, or warpwise elasticity, or both, may range from 1% to 370%, preferably from 3% to 100%, more preferably from 5% to 50%, measured according to ASTM D3107.

In the present disclosure, stretch according to ASTM D3107 is measured by means of a 3.0 lb. weight.

Advantageously, according to embodiments, the textile article may be selected according to the characteristics of the pattern of conductive biopolymer that is to be provided to the textile article.

According to embodiments, the biopolymer, provided with an electrically conductive material, may be provided on the side of the fabric which will be the external visible side of the fabric when a garment comprising the fabric is worn.

According to embodiments, the culture containing biopolymer-producing microorganisms further comprises the electrically conductive material.

For example, a textile article may be contacted with a culture including biopolymer-producing microorganisms and an electrically conductive material. The microorganisms may be cultured to produce a biopolymer including an electrically conductive material, so that the textile article is provided with a biopolymer comprising the conductive material. In this case, advantageously, the process of the invention may be performed as a one-step process.

According to embodiments, when the culture containing biopolymer-producing microorganisms comprises an electrically conductive material, the electrically conductive material in the culture is in an amount in the range of from 0.00005% to 3% by weight, preferably from 0.0001% to 1% by weight of the total culture medium weight.

According to embodiments, the electrically conductive material may be provided to the biopolymer after that the biopolymer has been produced on the textile article.

For example, a fabric may be contacted on at least one side with a culture of biopolymer-producing microorganisms, and such microorganisms may be cultured to produce a biopolymer onto the fabric. The biopolymer may be subsequently impregnated or printed (e.g., by screen printing and/or by digital printing) with a conductive material.

According to embodiments, the textile article may comprise the electrically conductive material. For example, when the biopolymer on the textile article is impregnated with an electrically conductive material, part of the conductive material may reach and/or contact the textile article. Also, for example, when a textile article provided with a biopolymer is dipped into a dispersion or solution of electrically conductive material, both the biopolymer and the textile article may be impregnated with the conductive material.

This is particularly true when, for example, the textile article comprises hydrophilic fibers or yarns.

As above mentioned, in embodiments, at least part of the textile article is coupled with a separately produced biopolymer.

Accordingly, in embodiments, the separately produced biopolymer is provided at least in part with the electrically conductive material before or after being coupled to said textile article.

For example, in embodiments, a biopolymer, e.g., microbial cellulose, may be produced by culturing biopolymer-producing microorganisms according to known methods. The biopolymer may be provided with an electrically conductive material, for example by dipping or printing, and subsequently coupled with a fabric, e.g., by crosslinking and/or sewing.

In embodiments, for example, a biopolymer, e.g., microbial cellulose, may be produced and coupled to a fabric (e.g., by cross-linking and/or by sewing). Subsequently, an electrically conductive material may be provided to the biopolymer on the fabric, e.g., by printing or dipping.

According to embodiments, the biopolymer is selected from microbial cellulose, microbial collagen, cellulose/chitin copolymer, microbial silk, and mixture thereof.

These biopolymers are known per se in the art.

According to embodiments, biopolymer-producing microorganisms are selected from bacteria, algae, yeast, fungi and mixtures thereof.

Preferably, biopolymer-producing bacteria are selected from Gluconacetobacter, Aerobacter, Acetobacter, Achromobacter, Agrobacterium, Azotobacter, Salmonella, Alcaligenes, Pseudomonas, Rhizobium, Sarcina, Streptoccoccus and Bacillus genus, and mixtures thereof, and biopolymer-producing algae are selected from Phaeophyta, Rhodophyta and Chrysophyta, and mixture thereof.

The electrically conductive material may be provided to the biopolymer according to known methods, for example by impregnation or printing. According to embodiments, the electrically conductive material is a carbonaceous material, e.g., a carbon-based electrically conductive ink which comprises a carbonaceous material. Preferably, the carbonaceous material is selected from the group consisting of activated carbon, high surface area carbon, graphene, graphite, activated charcoal, carbon nanotubes, carbon nanofibers, activated carbon fibers, graphite fibers, graphite nanofibers, carbon black and mixtures thereof.

Carbon-based electrically conductive inks are known per se in the art. Advantageously, the amount of electrically conductive material to be provided to at least part of the biopolymer may be adjusted to obtain, in a precise and reliable way, a desired electrical resistance value.

Advantageously, by adjusting the amount of the electrically conductive material, it is possible to calibrate the electrical conductivity of the electrically conductive composite textile article. For example, the electrically conductive composite textile article may have sheet resistance (also called “surface resistivity”) in the range from 10² Ohm/sq about to about 10⁹ Ohm/sq.

When the electrically conductive composite textile article is an electrically conductive composite fabric or garment, the sheet resistance may be measured according to TS EN 1149-1:2006.

When the electrically conductive composite textile article is an electrically conductive composite yarn, for example, the electrical resistance per unit of length may be measured by following the standard AATCC Test Method 84-2005, AATCC Test Method 84-2011, AATCC 76-2011, or BS EN 1149-1:2006.

Advantageously, when the biopolymer and/or the electrically conductive material are provided according to patterns, the dimensions and/or the amount of biopolymer and/or conductive material, may be adjusted, in order to obtain, for each pattern a desired electrical resistance value.

After the textile article has been provided with the biopolymer comprising the electrically conductive material, the electrically conductive composite textile article is dried, to obtain a dry or substantially dry electrically conductive composite textile article.

Preferably, when the biopolymer has been produced on the textile article by culturing biopolymer-producing microorganism on the textile article, the electrically conductive composite textile article is washed, to remove residual microorganisms, before drying.

According to embodiments, the process of the invention further comprises a step of providing at least part of the biopolymer with at least a softening agent, preferably a silicone softening agent.

In this case, advantageously, the biopolymer results to be particularly smooth and flexible.

Suitable softening agents are, for example, those disclosed in the European patent application number EP3476996A1, “A process for preparing a composite textile article including a biopolymer layer produced by microorganisms”, claiming priority from EP17198751.4, in the name of the present applicant.

For example, the softening agent may be applied by spraying it onto the biopolymer or by impregnating the biopolymer with the softening agent, e.g., by dipping at least the biopolymer into the soften agent in liquid form or into a solution or dispersion comprising it.

According to embodiments, one or more textile softeners may be included into the medium of the culture medium of biopolymer-producing microorganisms, so that the biopolymer is produced (i.e., grows) in the presence of the softening agent, to provide a biopolymer comprising the softening agent.

According to embodiments, the process of the invention further comprises a step of providing, e.g. coating, at least part of the biopolymer with at least one electrically insulating polymer.

Advantageously, by providing, e.g. coating, at least part of the biopolymer, i.e., the biopolymer that has been provided with an electrically conductive material, with at least one electrically insulating polymer, the electrically conductive composite textile article is protected or substantially protected from external electrical disturbance.

According to embodiments, the electrically insulating polymer may be selected from the group consisting of PU, PA, PP, PLA, PBT, PET, and silicone.

Advantageously, an electrically conductive composite fabric having may be obtained through the process of the invention.

Another object of the present invention is an electrically conductive composite textile article comprising a textile article and a biopolymer, wherein at least part of the biopolymer is provided with an electrically conductive material.

According to embodiments, the electrically conductive composite textile article is dry or substantially dry.

According to embodiments, the electrically conductive material may be provided to the biopolymer as a pattern of conductive material.

In other words, the electrically conductive material may be provided to at least part of the biopolymer according to a selected pattern, e.g., stripes. According to embodiments, the electrically conductive material in the dry electrically conductive composite textile article is in an amount ranging from 0.005% to 7.5% by weight, preferably from 0.01% to 5% by weight of the weight of the electrically conductive composite textile.

According to embodiments, the biopolymer may be provided to the textile article as a pattern of biopolymer.

In other words, the biopolymer may be provided to at least part of the textile article, e.g., a fabric, according to a selected pattern, e.g., stripes.

Advantageously, the electrically conductive composite textile article of the invention may be used in the production of, for example, capacitive proximity sensors, capacitive swipe sensors, capacitive touch pads, position sensitive touch sensors, and strain gauges.

According to embodiments, the textile article is selected from the group consisting of a yarn, a fabric and a garment.

According to embodiments, the electrically conductive composite textile article is a yarn which is at least in part provided with a biopolymer, wherein the biopolymer included at least one electrically conductive material. According to embodiments, the electrically conductive composite textile article is a yarn which is at least in part coated with a biopolymer, wherein the biopolymer included at least one electrically conductive material.

According to embodiments, at least part of the biopolymer is provided, e.g. coated, with at least one electrically insulating polymer, preferably with a silicone insulating polymer.

According to an aspect of the invention, a biopolymer which is provided at least in part with an electrically conductive material, i.e., an electrically conductive biopolymer, may be used for the production of textiles items (e.g., yarns, fabrics, and clothing articles), optionally without being provided to a base (i.e., supporting) textile article.

For example, the electrically conductive biopolymer may be tailored into a clothing item, e.g., a garment, or worked into a yarn.

An object of the present invention is thus a yarn, a fabric, or a garment consisting of, or essentially consisting of a biopolymer, i.e., a biopolymer that can be produced by a microorganism, which is at least in part provided with an electrically conductive material.

According to the present description, when an article or item is defined as “essentially consisting of the biopolymer”, it is meant that the essential structure of the article is made by the biopolymer, but other elements of the article or item may be made of other materials. For example, portions of one or more electrically conductive biopolymers may be sewn together using cotton yarns to provide a garment.

As above mentioned, the biopolymer can be grown and provided with an electrically conductive material. The biopolymer, before and/or after being provided with the conductive material may be worked into a yarn, a fabric or a garment, according to methods that are known, per se, in the art.

### BRIEF DESCRIPTION OF THE DRAWINGS

The invention will now be described, by way of example, with reference to the accompanying drawings, which have to be interpreted as illustrative and non-limiting schematic representations of exemplary embodiments of the invention. Also, according to common practice, the various features of the drawing are not necessarily to scale. On the contrary, the dimensions of the various features are arbitrarily expanded or reduced for clarity.

In the accompanying drawings:

FIG. 1 shows an embodiment of the composite textile article of the invention;

FIG. 2 shows an embodiment of the composite textile article of the invention, wherein the biopolymer is provided as a pattern of biopolymer;

FIG. 3 shows an embodiment of the composite textile article of the invention, wherein the electrically conductive material is provided as a pattern of conductive material;

FIG. 4 shows an embodiment of the composite textile article of the invention, wherein the biopolymer is provided as a pattern of biopolymer;

FIGS. 5A, 5B and 5C, show an embodiment of the present invention wherein the textile article is a yarn.

### DETAILED DESCRIPTION OF THE INVENTION

In the present description, when reference is made to a fabric, this definition includes the fabric present in a garment or clothing article.

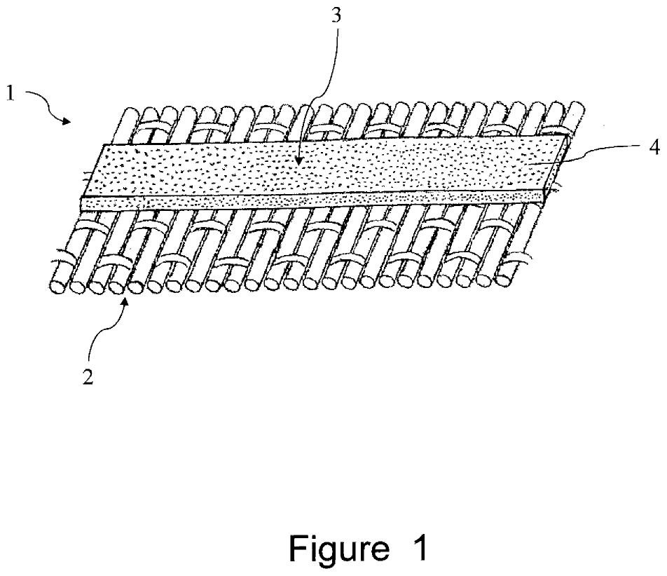

FIG. 1 schematically represents a perspective view of a portion of an exemplary electrically conductive composite textile article 1 according to the invention.

According to FIG. 1, the textile article is a fabric 2, in particular a woven fabric.

The fabric 2 is provided with a biopolymer 3, for example microbial cellulose, which comprises an electrically conductive material 4, for example a carbon based electrically conductive ink.

In the embodiment shown in FIG. 1, the whole or substantially the whole biopolymer 3 is provided with the electrically conductive material 4 in a homogeneous or substantially homogeneous manner.

According to embodiments, the electrically conductive material 4 in the electrically conductive composite textile article 1, after drying, may be in an amount ranging from 0.005% to 7.5% by weight, preferably from 0.01% to 5% by weight of the weight of the electrically conductive composite textile article 1.

For example, an electrically conductive material 4 may be applied by impregnating at least the biopolymer 3 with the conductive material.

According to embodiments, the biopolymer 3 may be grown directly onto the fabric 2.

For example, the fabric 2 may be contacted, at least in part, with a culture of biopolymer-producing microorganisms, which may be cultured to produce at least one biopolymer 3 onto the fabric 2.

According to embodiments, the biopolymer 3 is microbial cellulose.

For example, microbial cellulose can be produced by culturing strains of Acetobacter bacteria, such as strains of Acetobacter xylinum, and/or by culturing strains of Gluconacetobacter, such as strains of Gluconacetobacter hansenii.

A culture comprising biopolymer-producing microorganisms may be provided to a textile article according to known methods. For example, at least part of the textile article may be dipped into a culture comprising microorganisms to be impregnated with the culture. In other examples, the culture of microorganisms may be poured or sprayed onto the textile article. Subsequently, the electrically conductive composite textile article may be washed, to remove residual microorganisms, and dried.

In FIG. 1, the fabric 2 is provided with a stripe of biopolymer 3 comprising an electrically conductive material 4.

According to embodiments of the invention, when the biopolymer 3 is to be provided to a textile article according to a pattern and/or according to a predetermined defined shape, the biopolymer 3 may be produced by culturing biopolymer-producing microorganism in shaped containers, according to known methods, and subsequently applied to the textile article, e.g., to a fabric 2.

According to embodiments, when the biopolymer 3 is to be provided to a textile article according to a pattern and/or according to a predetermined defined shape, the biopolymer 3 may be grown directly on the textile article.

For example, a culture comprising biopolymer-producing microorganisms may be poured or sprayed on at least part of the textile article through a template, i.e., a stencil. Subsequently, the biopolymer-producing microorganism may be grown to obtain a shaped biopolymer 3 on the textile article.

Advantageously, when the template or stencil is removed after the biopolymer is grown on the textile article, e.g., a fabric, a biopolymer having a defined shape and/or pattern may be obtained.

In FIG. 1, the fabric 2 is provided with a stripe of biopolymer 3 comprising an electrically conductive material 4.

As above mentioned, the electrically conductive material 4 may be provided to the biopolymer 3, for example, by impregnating at least part of the biopolymer 3 with such conductive material 4, e.g., by contacting at least part of the biopolymer 3 with a carbon-based conductive ink.

According to embodiments, the culture including biopolymer-producing microorganisms further comprises the electrically conductive material. In this case, advantageously, the electrically conductive composite textile article 1 of the invention may be obtained according to a one-step process.

According to embodiments, when a culture including biopolymer-producing microorganisms and an electrically conductive material is used, the electrically conductive material 4 in the culture may be in an amount in the range of from 0.00005% to 3% by weight, preferably from 0.0001% to 1% by weight of the total culture medium weight.

For example, a fabric 2 may be contacted with a culture including biopolymer-producing microorganisms and an electrically conductive material 4, optionally using a template or a stencil. Subsequently, microorganisms may be grown in order to produce a biopolymer 3 including the conducive material 4.

According to embodiments, at least part of the biopolymer 3 may with provided with at least a softening agent.

According to embodiments, the culture including biopolymer-producing microorganisms may further comprise a softening agent.

For example, a fabric 2 may be contacted with a culture including biopolymer-producing microorganisms and a softening agent, in order to produce a biopolymer 3 including the softening agent directly onto the fabric 2.

According to embodiments, the culture including biopolymer-producing microorganisms may further comprise an electrically conductive material 4 and a softening agent.

According to embodiments, when the culture including biopolymer-producing microorganisms comprises a softening agent, the culture comprises the softening agent in an amount ranging from 0.5% to 2% by weight, preferably from 0.8 to 1.2% by weight of the final culture weight that is applied to the textile.

As above discussed, suitable softening agents are, for example, those disclosed in the European patent application number EP3476996A1, “A process for preparing a composite textile article including a biopolymer layer produced by microorganisms”, claiming priority from EP17198751.4, in the name of the present applicant.

Preferably, the softening agent is a silicone softening agent. Preferred silicone softening agents are micro-silicone softening agents.

For example, a suitable micro-silicone softening agent is a micro-silicone emulsion wherein micro-silicone has a particle size ranging from below 80 nm to 10 nm, preferably from below 60 nm to 10 nm, more preferably ranging from 40 nm to 10 nm, wherein the particle size is measured by Dynamic Light Scattering. For example, Ceraperm® 3P Liq. and SANSIL MIC 3145 are exemplary micro-silicone emulsions suitable to be used in the process of the invention. Ceraperm® 3P Liq. and SANSIL MIC 3145 are currently commercially available.

The softening agent may be sprayed onto the biopolymer 3, after that it has been provided to the textile article, e.g., to the fabric 2. Additionally or alternatively, the biopolymer 2 may be impregnated with the softening agent, e.g., by dipping into the softening agent in liquid form or into a solution or dispersion comprising it.

According to embodiments, the softening agent may be provided also to the fabric 2. For example, a fabric 2 provided with a biopolymer 3, optionally including an electrically conductive material 4, may be impregnated with a softening agent.

According to embodiments, the composite textile article 1 may comprise a plurality of stipes of biopolymer 3 including an electrically conductive material 4, wherein at least two stripes have different orientation.

For example, a fabric 2 may be provided with a first stripe of biopolymer 3 including an electrically conductive material 4 and, optionally, at least a second stripe, said second stripe being oriented according to a predetermined angle with respect to said first stripe.

Also, for example, a fabric 2 may be provided with a first stripe and a second stripe of biopolymer 3 including an electrically conductive material 4, wherein the second stripe may be perpendicular to said first stripe. Optionally, the fabric may further comprise a third stripe of biopolymer 3 including an electrically conductive material 4 which is oriented according to a predetermined angle with respect to both the first stripe and the second stripe.

According to embodiments, the electrically conductive composite textile article 1 is flexible. In this case, advantageously, when the electrically conductive composite textile article 1 comprises one or more stripes of biopolymer 3 including an electrically conductive material 4, the composite textile article 1 results to be particularly suitable for the production of strain gauges.

Strain gauges, also known as extensometers, are devices that are, per se, known in the art, and are suitable to measure strain on an object, i.e., to measure of deformation of an object relative to a reference length.

According to embodiments, the electrically conductive composite textile article 1 is particularly suitable for the production of strain gauges when it is provided with one or more stipes of biopolymer 3 including an electrically conductive material 4. For example, a plurality of stripes of biopolymer 3 may be provided to the fabric according to a plurality of different directions, for example to form a star, e.g., a 5-pointed star.

According to embodiments, the biopolymer 3 and/or the electrically conductive material 4 may be provided according to a ring shape.

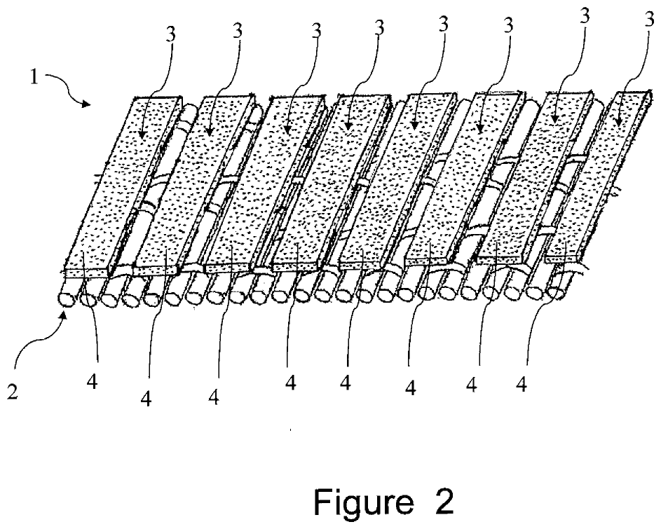

As above mentioned, according to embodiments, the biopolymer 3 may be provided to the fabric 2 according to a pattern. For example, the biopolymer 3 may be provided to the fabric 2 as a plurality of stripes of biopolymer 3. According to embodiments, the biopolymer 3 and/or the conductive material 4 may be provided according to a pattern of parallel stripes, as shown, for example, in FIG. 2, which show a perspective view of a portion of an exemplary embodiment of the electrically conductive composite textile article 1 according to the present invention.

In particular, FIG. 2 shows a fabric 2 which is provided with a pattern of parallel stripes of biopolymer 3, which includes an electrically conductive material 4.

Similarly to FIG. 1, also in the embodiment represented in FIG. 2, in each stripe of biopolymer 3, the whole or substantially the whole biopolymer 3 is provided with the conductive material 4 in a homogeneous or substantially homogeneous manner.

According to embodiments, when the biopolymer 3 is provided to a textile article according to a pattern, each portion of the pattern may have different dimension and/or thickness and/or may include a different amount of electrically conductive material 4.

In this case, advantageously, it is possible to obtain, for each pattern and element thereof, the desired value of electrical resistance in a precise and reliable way.

For example, different elements of the pattern may have different values of electrical resistance. For example, each element of the pattern may have sheet resistance (also called “surface resistivity”) in the range from 10² Ohm/sq about to about 10⁹ Ohm/sq.

For example, considering the embodiment schematically represented in FIG. 2, the stripes of biopolymer 3 may have different dimension and/or different thickness. The stripes may contain different amounts of conductive material 4. For example, each stripe may contain the electrically conductive material 4 in an amount ranging from 0.005% to 7.5% by weight, preferably from 0.01% to 5% by weight of the weight of the electrically conductive composite textile.

Advantageously, when the electrically conductive material 4 is provided according to a pattern of parallel stripes, the composite textile article 1 of the invention results to be particularly suitable for the production of unidirectional touchpads. For example, considering the exemplary embodiment of FIG. 2, the stripes of biopolymer 3 including an electrically conductive material 4 may be connected, e.g., singularly, to a sensing device, to measure the capacity of each stripe.

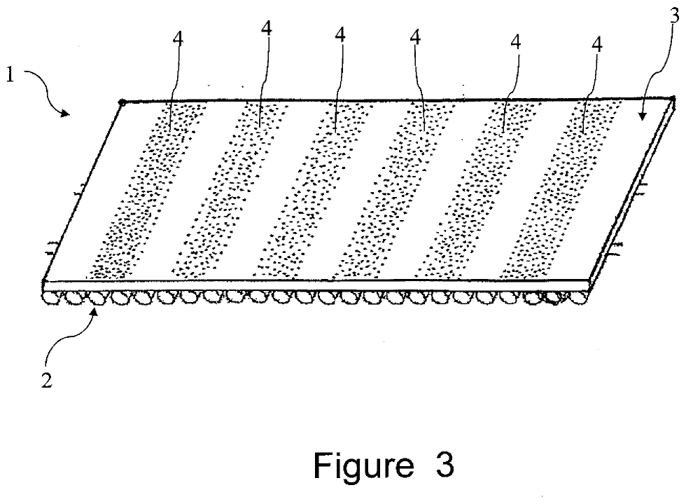

FIG. 3 shows a perspective view of a portion of another embodiment of the composite textile article 1 of the invention.

FIG. 3 schematically shows a fabric 2 provided on one of its sides with a biopolymer 3, which covers substantially the entirety of the fabric 2.

In the embodiment of FIG. 3, the biopolymer 3 is schematically represented in the form of a continuous layer, i.e., as a layer of biopolymer 3 that covers continuously (i.e. substantially without interruptions or without interruption) the fabric 2.

In the embodiment of FIG. 3, the electrically conductive material 4 is provided to the biopolymer according to a pattern, in particular as a plurality of parallel stripes.

The biopolymer layer 3 may be produced directly on the fabric 2, by culturing biopolymer-producing microorganisms directly on the fabric 2, as above discussed. The electrically conductive material 4 may be subsequently provided to at least part of the biopolymer 3. When the conductive material 4 is to be provided to the biopolymer 3 according to a pattern, the electrically conductive material 4 is preferably applied to the biopolymer 3 by printing. For example, a pattern of carbon-based ink may be printed to a biopolymer 3, e.g., microbial cellulose, according to a selected pattern and/or shape.

In embodiments, the conductive material 4 may be provided to a biopolymer 2 according to a pattern, for example, as a plurality of parallel stripes.

In embodiments, the electrically conductive material 4 may be provided to the biopolymer 3, e.g., by printing, and subsequently, the biopolymer 3 including the conductive material 4 may be coupled with a textile article, e.g. a fabric 2. In embodiments, the textile article, e.g., a fabric 2, is provided with a biopolymer 3 and, subsequently, an electrically conductive material 4 is applied to at least part of the biopolymer 3.

Similarly to the embodiment represented in FIG. 2, also the exemplary embodiment of the composite textile article 1 of the invention represented in FIG. 3 is suitable for the production of unidirectional touchpads.

In fact, in the embodiment of FIG. 3, the electrically conductive material 4 is provided to the biopolymer 3 as a plurality of parallel stripes which may be connected to a sensing device to measure the capacity of each stripe.

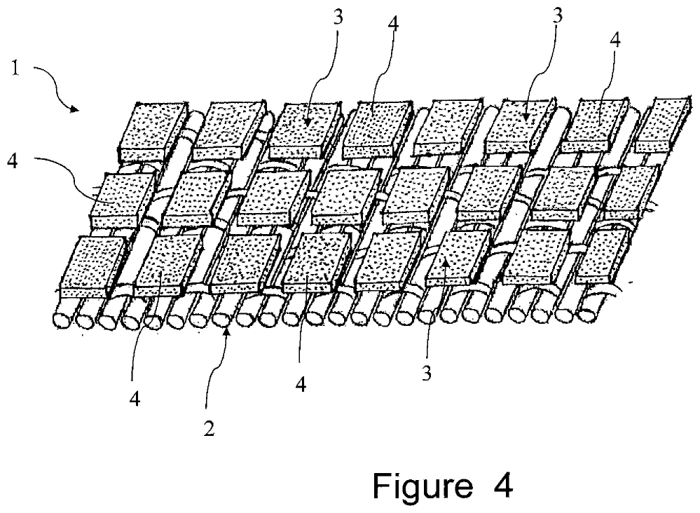

FIG. 4 shows perspective view of a portion of a further exemplary embodiment of the electrically conductive composite textile article 1 which comprises a pattern of biopolymer 3 including an electrically conductive material 4.

In particular, in FIG. 4, a fabric 2 is provided with a plurality of square elements of biopolymer 3, arranged according to perpendicular rows and columns.

FIG. 4 schematically represents an embodiment of the composite textile 1 wherein, in each square element, the biopolymer 3 is provided with the conductive material 4 in a homogeneous or substantially homogeneous manner.

In embodiments, the elements of biopolymer 3 may include all the same or substantially the same amount of electrically conductive material 4.

In embodiments, the elements of biopolymer 3 may include different amounts of electrically conductive material 4. For example, each element of biopolymer 3 may include the electrically conductive material 4 in an amount ranging from 0.005% to 7.5% by weight, preferably from 0.01% to 5% by weight of the weight of the electrically conductive composite textile.

In embodiments, the elements of biopolymer 3 may have different dimension and/or different thickness.

FIG. 4 schematically shows and embodiment wherein the elements of the pattern of biopolymer 3 have a substantially square shape.

According to embodiments, the elements of the pattern of biopolymer 3 may have any geometrical shape. For example, one or more elements of a pattern of biopolymer 3 may have a polygonal shape (rectangular, square, triangular, irregular, etc.), or a curved shape (e.g., circular, oval, elliptical) or a shape comprising both straight portions and curved portions.

According to embodiments, the biopolymer 3 may be provided as a continuous or substantially continuous layer to the fabric 2, and the electrically conductive material 4 may be provided to at least part of such biopolymer 3 according to a desired pattern, e.g., a plurality of elements arranged in columns and rows, preferably perpendicular rows and columns. According to embodiments, the biopolymer 3 and/or the electrically conductive material 4 may be provided to the fabric 2 as grid of biopolymer 3 and/or electrically conductive material 4.

Advantageously, when the electrically conductive material 4, or the biopolymer 3 including the conductive material 4, is provided according to a pattern of rows and columns of elements, preferably perpendicular rows and columns, or according to a grid pattern, the composite textile article 1 of the invention results to be particularly suitable for the production of bidirectional touchpads. For example, considering the exemplary embodiment of FIG. 4, the square elements of biopolymer 3 including an electrically conductive material 4 may be connected, singularly, to a sensing device, to measure the capacity of each element of biopolymer 3.

The embodiments shown in FIGS. 1-4 may preferably provide the presence of electrical connections (not shown) configured to electrically connect the patterns of electrically conductive material 4 to a detection device.

For example, the detection device may be configured to evaluate the capacitance value of one or more patterns of electrically conductive material 4 for the capacitive sensing of touch events.

A suitable detection device and its relevant use may be the one as described in the European patent application No. EP19174913.4 having the following title: “COMPOSITE YARN FOR THE POSITION SENSITIVE CAPACITIVE TOUCH SENSING”, claiming priority from EP18172676.1, and in the European patent application No. EP19199244.5 having the following title: “CAPACITIVE TOUCH SENSOR”, claiming priority from EP18196531.0. Such European patent applications are in the name of the present Applicant and the contents of which is incorporated herein by reference as if set forth in its entirety.

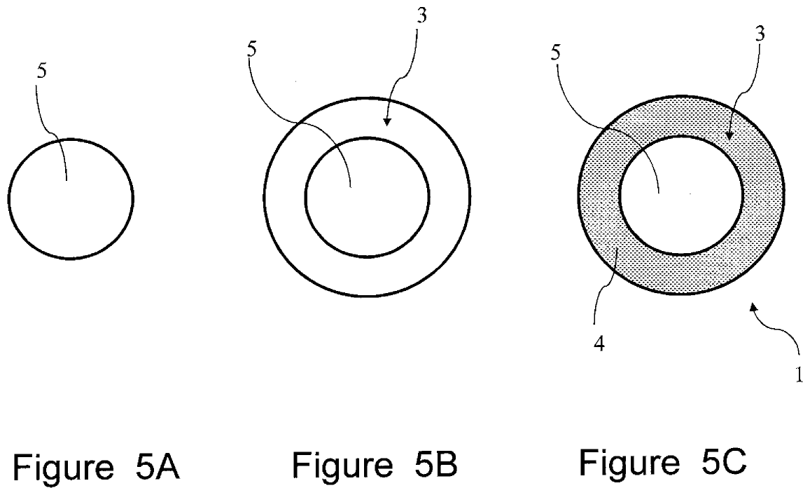

FIGS. 5A, 5B and 5C show an exemplary embodiment of the invention wherein the textile article is a yarn 5. In particular, FIG. 5A schematically shows a cross-section of a yarn 5, FIG. 5B schematically shows a cross-section of a yarn 5 provided (namely, coated, in the case of FIGS. 5B and 5C) coated with a biopolymer 3 and FIG. 5C schematically shows a cross-section of an electrically conductive composite textile 1 according to the invention, wherein the textile article is yarn 5, which is coated with a biopolymer 3 including a conductive material 4.

According to FIGS. 5A, 5B and 5C, the yarn 5 may be provided with a coating of biopolymer 3, i.e., with a biopolymer 3 which substantially envelops the yarn 5. A conductive material 4 may be subsequently applied. For example, a yarn 5 may be impregnated with a culture of biopolymer-producing microorganisms, which may be cultured in order to grow the biopolymer 3 directly onto the yarn 5. Subsequently, the yarn 5 provided with a biopolymer 3 may be impregnated with an electrically conductive material 4, e.g., a conductive ink, to obtain a composite textile 1 having conductive properties, in this case, a composite yarn having electrical conductivity properties.

In embodiments, the culture of biopolymer-producing microorganisms may include at least an electrically conductive material 4. In this case, advantageously, the yarn 5 may be provided with a biopolymer 3 including a conductive material 4 according to a one-step process.

As above mentioned, a culture containing biopolymer-producing microorganisms, optionally containing an electrically conductive material 4, may be provided to a yarn through known methods.

According to embodiments, a culture containing biopolymer-producing microorganisms, optionally containing an electrically conductive material 4, may be provided to a yarn through the process discloses in the European patent application number EP19179217.5, “A process for providing a culture of microorganisms to an elongated element”, claiming priority from international application PCT/EP2018/065506, in the name of the present applicant.

For example, according to EP19179217.5, as well as to PCT/EP2018/065506, a culture containing biopolymer-producing microorganisms may be provided to a yarn by means of an apparatus comprising a feeding device having an outlet for dispensing such culture containing biopolymer-producing microorganisms from the outlet, and a yarn source to supply a yarn to the feeding device, wherein the apparatus is configured so that the culture containing microorganisms contacts at least part of the yarn when the culture is dispensed from the outlet. In this case, when a certain amount of culture is provided to the yarn, a certain amount of culture is dispensed from the outlet in order to feed to the yarn a fixed amount of culture that provides a sufficient amount of culture to the yarn, avoiding excessive culture being wasted. In other words, the dispensing of the culture may be adjusted so that, advantageously, the culture is dispensed from the outlet of the feeding device at a flow rate selected so that the culture envelops the yarn but is prevented from falling from the yarn, and from drying out at the outlet.

As above mentioned, the culture containing biopolymer-producing microorganisms, may optionally further comprise an electrically conductive material 4 and/or a softening agent. In this case, preferably, the culture may include an electrically conductive material in an amount in the range of from 0.0001% to 1% by weight of the total culture medium weight.

Advantageously, when the textile article is a yarn 5, the process of the invention allows for the production of an electrically conductive composite yarn, i.e., a yarn having electrical conductivity properties. Such electrically conductive composite yarn may be used in addition to or as an alternative to the currently available electrically conductive yarns.

According to an aspect of the present invention, the electrically conductive biopolymer, maintains the same, or substantially the same structural characteristics (e.g., crystal structure, nano-porous network structure) of the biopolymer when it does not include the conductive material.

Advantageously, in embodiments, the biopolymer may be provided with the electrically conductive material in a homogeneous or substantially homogeneous manner; in other words, the concentration of the electrically conductive material may substantially constant in the biopolymer, or in a portion thereof.

According to embodiments, the electrically conductive biopolymer may be tailored into a clothing item, e.g., a garment, or worked into a yarn.

According to embodiments, an item, in particular a textile item of article such as, for example, a yarn, a fabric, or a garment, or a portion thereof, may consist of, or essentially consist of the electrically conductive biopolymer. As above mentioned, the biopolymer can be grown and provided with an electrically conductive material. The biopolymer, before and/or after being provided with the conductive material may be worked into a yarn, a fabric or a garment, according to methods that are known, per se, in the art.

The present invention provides for several advantages. For example, the present invention allows for the production of article having electrical conductivity properties in an easy, fast, and cost-effective way.

Moreover, the present invention allows to obtain an article having electrical conductivity properties which is reliable and that may be used for several applications, in particular in the textile field.

Additionally, according to the present invention, the conductive material may be easily included into the biopolymer, without jeopardizing the structure of the biopolymer.

1. A process for producing an electrically conductive composite textile article (1), wherein at least part of a textile article (2, 5) is provided with a biopolymer (3), and wherein at least part of said biopolymer (3) is provided with an electrically conductive material (4).

2. Process according to claim 1, wherein the step of providing at least part of a textile article (2, 5) with a biopolymer (3) comprises a step of contacting at least part of said textile article (2, 5) with a culture of biopolymer-producing microorganisms, and culturing said biopolymer-producing microorganisms, so that at least one biopolymer (3) is produced on said textile article (2, 5).

3. Process according to claim 2, wherein said culture of biopolymer-producing microorganisms further comprises said electrically conductive material (4), or wherein said electrically conductive material (4) is provided to said biopolymer (3) after said biopolymer (3) is produced on said textile article (2, 5).

4. A process according to claim 1, wherein at least part of said textile article (2, 5) is coupled with a separately produced biopolymer (3).

5. Process according to claim 4, wherein said separately produced biopolymer (3) is provided at least in part with said electrically conductive material (4) before or after being coupled to said textile article (2, 5).

6. Process according to claim 1, wherein said biopolymer (3) is provided to said textile article (2, 5) according to a pattern.

7. Process according to claim 1, wherein said electrically conductive material (4) is applied to said biopolymer (3) according to a pattern.

8. Process according to claim 1, wherein said textile article (2, 5) is selected from the group consisting of a yarn (5), a fabric (2) and a garment.

9. Process according to claim 8, wherein said textile article (2, 5) is a yarn (5) and wherein at least part of said yarn (5) is provided with said biopolymer (3).

10. Process according to claim 1, wherein said biopolymer (3) is selected from microbial cellulose, microbial collagen, cellulose/chitin copolymer, microbial silk, and mixture thereof.

11. Process according to claim 1, wherein said electrically conductive material (4) is a carbonaceous material, selected from the group consisting of activated carbon, high surface area carbon, graphene, graphite, activated charcoal, carbon nanotubes, carbon nanofibers, activated carbon fibers, graphite fibers, graphite nanofibers, carbon black and mixtures thereof.

12. Process according to claim 1, further comprising a step of providing at least part of said biopolymer (3) with at least a softening agent.

13. Process according to claim 1, further comprising a step of providing at least part of said biopolymer (3) with at least one electrically insulating polymer selected from the group consisting of PU, PA, PP, PLA, PBT, PET, and silicone.

14. An electrically conductive composite textile article (1) comprising a textile article (2, 5) and a biopolymer (3), wherein at least part of said biopolymer (3) is provided with an electrically conductive material (4).

15. Electrically conductive composite textile article (1) according to claim 14, wherein said electrically conductive material (4) is provided to said biopolymer (3) as a pattern of electrically conductive material (4).

16. Electrically conductive composite textile article (1) according to claim 14, wherein said biopolymer (3) is provided to said textile article (2, 5) as a pattern of biopolymer (3).

17. Electrically conductive composite textile article (1) according to claim 14, wherein said textile article (2, 5) is selected from the group consisting of a yarn (5), a fabric (2) and a garment.

18. Electrically conductive composite textile article (1) according to claim 14, wherein at least part of said biopolymer (3) is coated with at least one electrically insulating polymer selected from the group consisting of PU, PA, PP, PLA, PBT, PET, and silicone.

19. A yarn, or a fabric, or a garment, consisting of of a biopolymer produced by a microorganism, wherein at least part of said biopolymer is provided with an electrically conductive material.
